(19) United States
(12) Patent Application Publication
(10) Pub. No.: US 2025/0110004 A1
(43) Pub. Date: Apr. 3, 2025

(54) INSPECTION DEVICE, INSPECTION METHOD, AND DISC BRAKE PLATE MANUFACTURING METHOD

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 18/804,394

(22) Filed: Aug. 14, 2024

(30) Foreign Application Priority Data
Sep. 29, 2023 (JP) 2023-170382

(51) Int. Cl. G01M 1/12

(52) U.S. Cl. CPC G01M 1/122

(57) ABSTRACT

An inspection device includes a support section configured to, on an upper end portion thereof, support an inspection target having a plate shape; and a force sensor coupled to a lower end portion of the support section and configured to detect a force in a gravitational direction and a moment about an axis orthogonal to the gravitational direction, the force and the moment acting on the support section from the inspection target in a non-rotating state.

This Nonprovisional application claims priority under 35 U.S.C. § 119 on Patent Application No. 2023-170382 filed in Japan on Sep. 29, 2023, the entire contents of which are hereby incorporated by reference.

### TECHNICAL FIELD

The present invention relates to an inspection device, an inspection method, and a disc brake plate manufacturing method, each of which inspects a center of gravity of an inspection target having a plate shape.

### BACKGROUND ART

Attachment state inspection devices for brake discs have been known which are configured to test whether or not the brake discs are fixed so as to be perpendicular to axles. For example, an attachment state inspection device for a brake disc which is disclosed in Patent Literature 1 includes: fixation means detachably fixed to a bolt or a nut coupled to a non-rotating portion for rotatably supporting the brake disc; a brake disc contact member made up from an elastic member that can abut on a side surface of the brake disc; connecting means for supporting the brake disc contact member to the fixation means so that a position of the brake disc contact member is adjustable; a strain gauge provided to a flexible portion of the brake disc contact member; and attachment state determination means configured to determine an attachment state of the brake disc on the basis of an output from the strain gauge.

Also, a technology has been known which is configured to measure a center of gravity of a processed product having a plate shape, such as a brake disc, and test whether or not a position of the center of gravity measured coincides with a position of a center of gravity of a normal product. As one type of inspection devices that can carry out such test, a static balance inspection machine has been known.

### CITATION LIST

### Patent Literature

[Patent Literature 1]

Japanese Patent Application Publication Tokukaihei No. 6-323352

### SUMMARY OF THE INVENTION

### Technical Problem

However, a conventional static balance inspection machine cannot find out a moment applied and a coordinate of the center of gravity.

It is an object of an aspect of the present invention to achieve an inspection device, an inspection method, and a disc brake plate manufacturing method, each of which makes it possible to inspect a center of gravity of an inspection target having a plate shape and detect a moment applied and a coordinate of the center of gravity.

### Solution to Problem

In order to solve the foregoing problem, an inspection device in accordance with an aspect of the present invention is an inspection device configured to inspect a center of gravity of an inspection target having a plate shape, the inspection device including: a support section configured to, on an upper end portion thereof, support the inspection target; and a force sensor coupled to a lower end portion of the support section and configured to detect a force in a gravitational direction and a moment about an axis orthogonal to the gravitational direction, the force and the moment acting on the support section from the inspection target in a non-rotating state.

In order to solve the foregoing problem, an inspection method in accordance with an aspect of the present invention is an inspection method for inspecting a center of gravity of an inspection target having a plate shape with use of the above-described inspection device, the method including: a support step of supporting the inspection target on the upper end portion of the support section; and a detection step of detecting, with use of the force sensor, the force in the gravitational direction and the moment about the axis orthogonal to the gravitational direction, the force and the moment acting on the support section from the inspection target supported in the support step.

In order to solve the foregoing problem, a method for manufacturing a disc brake plate, in accordance with an aspect of the present invention includes: a turning processing step of subjecting an inspection target which has a plate shape and which is a base material of the disc brake plate to a turning process; and an inspection step of inspecting, with use of the above-described inspection device, a center of gravity of the inspection target which has been subjected to the turning process in the turning processing step.

### Advantageous Effects of Invention

According to an aspect of the present invention, it is possible to achieve an inspection device, an inspection method, and a disc brake plate manufacturing method, each of which makes it possible to inspect a center of gravity of an inspection target having a plate shape and detect a moment applied and a coordinate of the center of gravity.

### BRIEF DESCRIPTION OF DRAWINGS

FIG. 1 is a cross-sectional view illustrating an inspection device in accordance with an embodiment of the present invention.

FIG. 2 is a block diagram illustrating a configuration of the inspection device illustrated in FIG. 1.

FIG. 3 is a perspective view illustrating a force sensor included in the inspection device illustrated in FIG. 1.

FIG. 4 is an example a displayed screen showing an inspection result from the inspection device illustrated in FIG. 1.

FIG. 5 is a flowchart for explaining the processing steps of an inspection method in accordance with an embodiment of the present invention.

FIG. 6 is a flowchart for explaining the processing steps of a manufacturing method in accordance with an embodiment of the present invention.

### DESCRIPTION OF EMBODIMENTS

### Configuration of Inspection Device

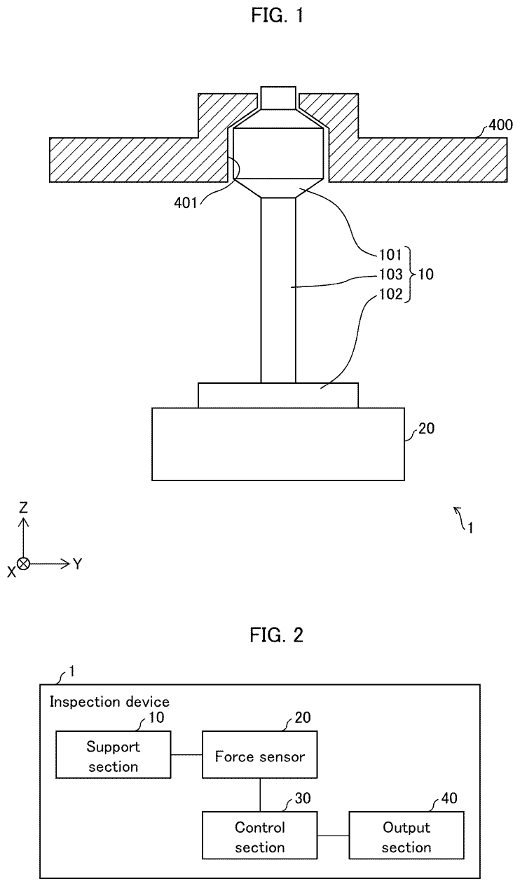

With reference to FIG. 1 and FIG. 2, the following description will discuss an inspection device 1 in accordance with an embodiment of the present invention. FIG. 1 is a cross-sectional view illustrating the inspection device 1. FIG. 2 is a block diagram illustrating a configuration of the inspection device 1. For simplification of description, in FIG. 1, some of the components are illustrated as a cross-sectional view.

The inspection device 1 is an inspection device configured to inspect a center of gravity of an inspection target 400 having a plate shape. Here, the inspection target 400 is, for example, a disc-shaped casting having a draft angle which is a base material of a disc brake plate and which has been subjected to a turning process. The inspection target 400 can be also expressed as a disc brake plate having been subjected to a turning process. However, the inspection target 400 is not limited to the disc brake plate having been subjected to a turning process. The inspection target 400 may be, for example, a structure having a disc shape or a structure having a planar rectangular shape. Such inspection targets having a plate shape may be not symmetrical.

The inspection device 1 includes a support section 10 and a force sensor 20. The support section 10 is a structure in the shape of a pole having a center axis in a vertical direction. Note that in the present embodiment, a vertical direction is defined as a Z axis. Also drawings show XYZ three-dimensional coordinate systems in which X-axis and Y-axis directions are defined with a plane perpendicular to the Z axis set as a XY-plane.

The support section 10 includes an upper end portion 101 located at a tip thereof on a Z-axis positive direction side, a lower end portion 102 corresponding to an end portion thereof on a Z-axis negative direction side, and a middle portion 103 via which the upper end portion 101 and the lower end portion 102 are connected. On the upper end portion 101, the inspection target 400 is placed. In a case where the inspection target 400 is the above-described disc brake plate having been subjected to a turning process, the upper end portion 101 is fitted to a recess (fitting portion 401 in FIG. 1) which has a draft angle and which is provided to a center portion of the disc brake plate. The upper end portion 101 has a structure having, at a tip thereof, a tapered portion so as to be favorably fitted to a fitting portion of an inspection target even if the type of the inspection target is changed. In this way, the upper end portion 101 supports the inspection target 400.

The middle portion 103 is a member in the shape of a pole having a small diameter. To one end of the middle portion 103, the upper end portion 101 is fixed, and to the other end, the lower end portion 102 is fixed. The small diameter thereof is not particularly limited, provided that the diameter is smaller than the diameter of the inspection target. The length thereof in the Z-axis direction is also not particularly limited, provided that the length allows for a state in which the inspection target is supported only by the upper end portion 101.

The lower end portion 102 is an end portion of the support section 10 on the Z-axis negative direction side. To the lower surface of the lower end portion 102 (the surface facing in the Z-axis negative direction), the force sensor 20 is coupled. The lower end portion 102 has a flange portion further protruding in a diameter expansion direction than an outer peripheral surface of the middle portion 103. In other words, the lower end portion 102 has a flange shape and further protrudes in a diameter expansion direction than the outer peripheral surface of the middle portion 103. The lower end portion 102 (flange portion) protrudes in a diameter expansion direction, so as to successfully secure a broad connection area with the force sensor 20.

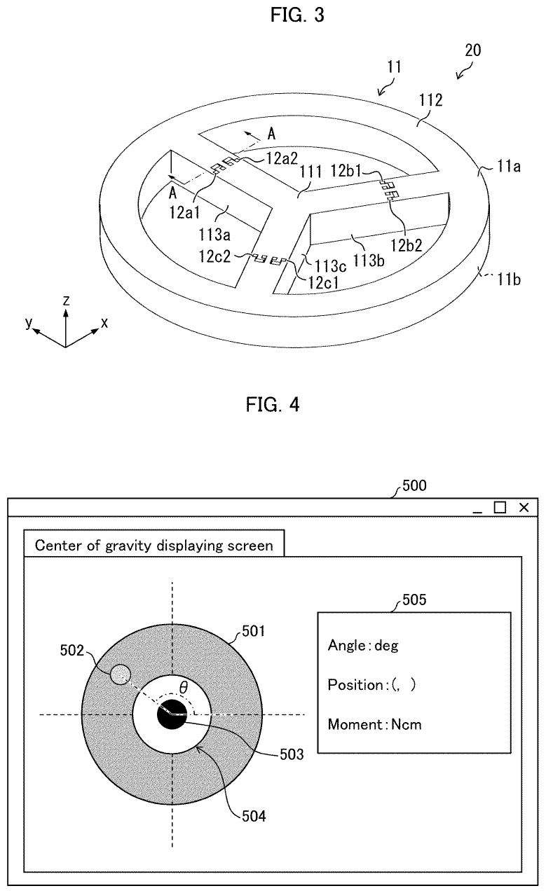

The force sensor 20 is coupled to the lower end portion 102 of the support section 10 and is configured to detect a force in a gravitational direction and a moment about an axis orthogonal to the gravitational direction, the force and the moment acting on the support section 10 from the inspection target 400 in a non-rotating state. The force sensor 20 is a six-axis force sensor but may be alternatively a three-axis force sensor. With reference to FIG. 3, the following will describe the force sensor 20 which is a six-axis force sensor.

FIG. 3 is a perspective view illustrating the force sensor 20 which is a six-axis force sensor. As illustrated in FIG. 3, the force sensor 20 includes a strain element 11 and a strain gauge group consisting of six strain gauges 12a1, 12a2, 12b1, 12b2, 12c1, and 12c2. Here, the six-axis force sensor refers to a force sensor capable of detecting the following components of an external force: an X-axis direction component, a Y-axis direction component, a Z-axis direction component, a moment component about the X-axis, a moment component about the Y-axis, and a moment component about the Z-axis. Note that the strain element 11 is disposed so that two main surfaces of the strain element 11 are in parallel with an XY-plane. One of the paired main surfaces of the strain element 11 which is on the Z-axis positive direction side is called a main surface 11a, and the other of the paired main surfaces of the strain element 11 which is on the Z-axis negative direction side is called a main surface 11b.

Note that the force sensor 20 is one example and may be another existing force sensor. For example, to the configuration of the force sensor, also the force sensor described in FIG. 1 and FIG. 2 of Japanese Patent Application Publication Tokukai No. 2020-165898 (Tokugan 2019-068598) is applicable.

The force sensor 20 includes, in addition to the strain element 11 and the strain gauges 12a1, 12a2, 12b1, 12b2, 12c1, and 12c2, a plurality of resistor elements and a plurality of bridge circuits. However, the description in the present embodiment will discuss the strain element 11 and the strain gauges 12a1, 12a2, 12b1, 12b2, 12c1, and 12c2, and does not discuss the plurality of resistor elements and the plurality of bridge circuits. Configurations of the plurality of resistor elements and the plurality of bridge circuits may be as those of existing force sensors (e.g., the force sensor shown in FIG. 1 and FIG. 2 of Japanese Patent Application Publication Tokukai No. 2020-165898).

The strain element 11 is a plate-shaped member made of a material with a spring property. As shown in FIG. 3, the strain element 11 includes a core portion 111, a frame portion 112 surrounding the core portion 111, and arm portions 113a to 113c via which the core portion 111 and the frame portion 112 are connected to each other. A material of which the strain element 11 is made may be (i) an electric conductor such as an aluminum alloy, an alloy steel, or a stainless steel or (ii) a dielectric such as a ceramic material, a resin, or glass, for example. In the present embodiment, the strain element 11 is made of a ceramic material, which is one example of the dielectric.

A method for forming the strain element 11 may be, for example, machining of a base material that is a single plate-shaped member having a uniform thickness. The machining may be cutting, for example. The cutting is preferably numerical controlled (NC) machining. Note that, if external force is exerted on the core portion 111 while the frame portion 112 is in a fixed state, the arm portions 113a to 113c undergo a strain that varies in accordance with that external force. Therefore, the core portion 111 may be referred to as “force receiver”, and the frame portion 112 may be referred to as “fixing portion”.

The force sensor 20 is configured such that the core portion 111 is coupled to a lower surface of the lower end portion 102 (flange portion) of the support section 10 illustrated in FIG. 1 so that the main surface 11a on the Z-axis positive direction side which is one main surface of the paired main surfaces of the strain element 11 faces the lower surface. The lower end portion 102 (flange portion) of the support section 10 has a size that enables the end portion 102 (flange portion) to be coupled to the core portion 111. The center axis of the middle portion 103 of the support section 10 is located on the center point of the strain element 11. Such a configuration allows the force sensor 20 to cause an external force, that is, a force acting on the support section 10 from the inspection target 400 in a non-rotating state to act on the core portion 111. The force sensor 20 detects a Z-axis direction component of this force. This corresponds to a “force in a gravitational direction acing on the support section 10 from the inspection target 400 in a non-rotating state”. In addition, the force sensor 20 detects a moment component of this force about the X axis and a moment component of this force about the Y axis. These correspond to a “moment about an axis orthogonal to the gravitational direction”.

There is no particular limitation on the shape of the core portion 111. In the present embodiment, the core portion 111 is in the shape of a pole with a substantially triangle base (i.e., substantially in the shape of a triangular pole). There is no particular limitation on the shape of the frame portion 112, as well. In the present embodiment, the frame portion 112 is in the shape of a ring. The frame portion 112 has an outer peripheral portion and an inner peripheral portion that have a substantially circular shape and that are concentric to each other. As described above, the strain element 11 is formed by machining a single base material having a uniform thickness. Thus, a thickness of the core portion 111 is substantially equal (in the present embodiment, equal) to a thickness of the frame portion 112. The core portion 111 is disposed inside the inner peripheral portion of the frame portion 112 such that a center of gravity of the core portion 111 coincides with a center of the frame portion 112 which is in the shape of a ring.

In the present embodiment, the arm portions 113a to 113c are each in the shape of a pole having a substantially quadrangular cross-section and extending along one direction (i.e., substantially in the shape of a quadrangular pole). There is no limitation on the number of arm portions 113a to 113c. In the present embodiment, the number of arm portions 113a to 113c is three. The arm portion 113a extends from the core portion 111 in the Y-axis positive direction so as to connect the core portion 111 with the frame portion 112. The arm portion 113b extends, in the XY-plane, from the core portion 111 in a direction at an angle of −120° relative to the Y-axis negative direction (i.e., at an angle of 120° clockwise from the y-axis negative direction) so as to connect the core portion 111 with the frame portion 112. The arm portion 113c extends, in the XY-plane, from the core portion 111 in a direction at an angle of +120° relative to the Y-axis negative direction (i.e., at an angle of 120° counterclockwise from the Y-axis negative direction) so as to connect the core portion 111 with the frame portion 112.

Note that the shapes of the core portion 111, the frame portion 112, and the arm portions 113a to 113c are not limited to the above-described shapes. For example, the core portion 111, the frame portion 112, and the arm portions 113a to 113c may have the shapes as shown in FIG. 1 of Japanese Patent Application Publication Tokukai No. 2020-165898.

As illustrated in FIG. 2, the inspection device 1 further includes a control section 30 (identification section) that can control the components. The control section 30 acquires an output signal from the force sensor 20. The control section 30 acquires a signal indicating a force in a gravitational direction (Z-axis negative direction) and a moment about an axis orthogonal to the gravitational direction, the force and the moment being detected by the force sensor 20 and acting on the support section 10 from the inspection target 400 in a non-rotating state. In addition, the control section 30 identifies the center of gravity of the inspection target 400. When the moment component about the X axis and the moment component about the Y axis are detected by the force sensor 20, this indicates that a position of the center of gravity is displaced. Therefore, the fact that the weight can be calculated with use of the Z-axis direction component enables the control section 30 to find out the position displaced from the center position, that is, a position of the center of gravity, by dividing the value of the moment component about the X axis (or the moment component about the Y axis) by the weight.

Further, the control section 30 identifies whether or not the identified center of gravity is located at a position of the center of gravity that the inspection target 400 is required to have. For this identification, the control section 30 uses information on the position of the center of gravity that the inspection target 400 is required to have and information on the center of gravity having been identified on the basis of the output signal from the force sensor 20. That is, to the control section 30, information on the inspection target 400 is registered in advance or inputted in advance, and the control section 30 acquires information on the center of gravity that the inspection target 400 is required to have, via a server, for example. Note that it is also possible that the control section 30 itself stores the information on the center of gravity that the inspection target 400 is required to have.

Here, the information on the center of gravity that the inspection target 400 is required to have is information indicating a position coordinate of the center of gravity that the inspection target 400 is required to have. The position coordinate of the center of gravity that the inspection target 400 is required to have may include a coordinate representing a predetermined allowable range of a position of the center of gravity that the inspection target 400 is required to have.

The control section 30 compares a position coordinate of the center of gravity having been identified on the basis of the output signal from the force sensor 20 (hereinafter, may be referred to as an identified center of gravity) and a position coordinate of the center of gravity that the inspection target 400 is required to have (hereinafter, may be referred to as a center of gravity of a normal product). The control section 30 then identifies whether or not the identified center of gravity is located at the position of the center of gravity of the normal product (whether or not the identified center of gravity is located within an allowable range that enables the inspection target 400 to be regarded as the normal product). One cause for the identified center of gravity to be located at a position coordinate different from the center of gravity of the normal product may be a structural defect of the inspection target 400 itself. Examples of the structural defect of the inspection target 400 itself include a deformation and chip. In addition, in a case where the inspection target 400 is a disc-shaped casting having been subjected to a turning process and is a base material of a disc brake plate, a defect due to casting and a defect due to a turning process are included.

Here, the control section 30 also identifies a polar angle (unit: deg) obtained in a case where a position of the center of gravity of the inspection target 400 is represented by a polar coordinate in which a position of the center of gravity of the normal product is regarded as the origin, on the basis of the position coordinate of the identified center of gravity and the position coordinate of the center of gravity of the normal product; and a moment (unit: Ncm) about an axis orthogonal to a gravitational direction. Note that the control section may identify at least one of the polar angle and the moment.

As illustrated in FIG. 2, the inspection device 1 includes an output section 40 configured to output a result identified by the control section 30. The output section 40 outputs the result identified by the control section 30, that is, information indicating whether or not the identified center of gravity is the center of gravity of the normal product (center of gravity located within an allowable range). In a case where the output section 40 includes a display device, an aspect is possible in which the display screen of the display device displays an image obtained by combining an image showing the identified center of gravity and an image showing the center of gravity of the normal product (center of gravity located within an allowable range) into an image schematically showing a plan view of the inspection target 400. This will be described with reference to FIG. 4.

FIG. 4 illustrates an example of an image 500 displayed on the display screen of the display device included in the output section 40. In the image 500, an image 501 schematically showing a plan view of the inspection target 400 includes an image 502 showing the identified center of gravity, an image 503 showing the center of gravity of the normal product, and an image 504 showing an allowable range of the center of gravity. In addition, the image 500 includes, on a right side thereof, an image 505 displaying calculated values of a position coordinate of the identified center of gravity described above, the polar angle (illustrated as “θ” in FIG. 4 for convenience of description) described above, and the moment (unit: Ncm) described above. Having such a function of notification by displaying enables a worker in an inspection site or a manufacturing site in which the inspection target is manufactured to be informed of the center of gravity of the inspection target 400, thus making it possible to inform the worker of whether the inspection target is the normal product (a product or a structure which is a base material of a product).

Note that the image 500 in FIG. 4 may display, as an image in graph form, for example, measurement data obtained by the force sensor 20 as well as the images 501 to 505. Alternatively, the image 500 in FIG. 4 may display a result of determination of whether the inspection target 400 is the normal product having the center of gravity of the normal product (center of gravity within an allowable range), instead of displaying the images 501 to 505. For example, a configuration may be employed in which in a case where the inspection target 400 is the normal product, the word “OK” is displayed, whereas in a case where the inspection target 400 is not the normal product, the word “NG” is displayed. Note that the display devices as above may be provided also to a management room located apart from the turning process site, as well as to the turning process site.

As described above, the inspection device 1 in accordance with the present embodiment makes it possible to, with use of the force sensor 20 coupled to the lower end portion 102 of the support section 10, detect a force in a gravitational direction and a moment about an axis orthogonal to the gravitational direction, the force and the moment acting on the support section 10 from the plate-shaped inspection target 400 in a non-rotating state. This makes it possible to statically identify a position of the center of gravity of the inspection target 400. The inspection device 1 in accordance with the present embodiment can be also expressed as a static balance inspection machine. Further, the above configuration makes it possible to identify the presence or absence of displacement from a position of the center of gravity of the normal product, thus making it possible to identify whether or not the inspection target 400 is the normal product.

Further, since the inspection device 1 in accordance with the present embodiment can statically identify a position of the center of gravity of the inspection target with use of the single force sensor 20, the control is simple, and it is possible to carry out calibration in a short time.

As described above, the lower end portion 102 of the support section 10 has a flange portion further protruding in a diameter expansion direction than the outer peripheral surface of the middle portion 103. This makes it easier to, with use of a force sensor, detect a force in a gravitational direction and a moment about an axis orthogonal to the gravitational direction, the force and the moment acting on the support section from the inspection target.

Note that it is also possible that the inspection device 1 uses the force sensor 20 to measure a weight of the inspection target 400 in a state of being supported by the support section 10.

### Inspection Method

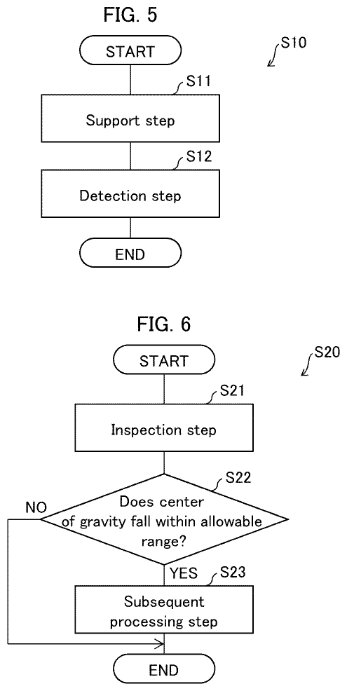

FIG. 5 is a flowchart illustrating the process of a method for inspecting the center of gravity of an inspection target having a plate shape with use of the inspection device 1 in accordance with the present embodiment. The inspection method (S10) includes a support step (S11) and a detection step (S12).

The support step S11 is a step of supporting the inspection target 400 on the upper end portion 101 of the support section 10.

In the detection step S12, a force in a gravitational direction and a moment about an axis orthogonal to the gravitational direction are detected with use of the force sensor 20, the force and the moment acting on the support section 10 from the inspection target 400 supported by the upper end portion 101 in the support step S11.

In the detection step S12, it is possible to identify the center of gravity of the inspection target 400 by, with use of the force sensor 20, detecting a force in a gravitational direction and a moment about an axis orthogonal to the gravitational direction, the force and the moment acting on the support section 10 from the inspection target 400. With regard to the detection by the force sensor 20, which is described above, in the detection step S12, the force sensor 20 detects the following components of a force in a gravitational direction: the Z-axis direction component, the moment component about the X axis, and the moment component about the Y axis, and the control section 30 acquires the detection results as an output signal and identifies at least one of a position coordinate of the center of gravity of the inspection target 400, the above-described polar angle, and the above-described moment of the inspection target. This makes it possible to inspect the center of gravity of the inspection target 400.

Note that the detection step S12 may include a step of notification by the above-described output section 40 (see FIG. 2).

The above inspection method S10 makes it possible to, through detection by the force sensor 20, identify a position of the center of gravity of an inspection target. This makes it possible to identify the presence or absence of displacement from a position of the center of gravity of the normal product and to identify whether or not the inspection target is the normal product.

### Method for Manufacturing Product

With use of the above-described inspection method, a turning processing step of subjecting a plate-shaped inspection target which is a base material of a product (e.g., a disc brake plate) to a turning process and an inspection step of inspecting the center of gravity of the plate-shaped inspection target having been subjected to the turning process can be incorporated into a method for manufacturing a product. With reference to FIG. 6, the following will describe an aspect of the method for manufacturing a product. FIG. 6 is a flowchart illustrating the process of a product manufacturing method in accordance with the present embodiment. As illustrated in FIG. 6, the product manufacturing method (S20) includes an inspection step (S21), a determination step (S22), and a subsequent processing step (S23).

The inspection step S21 includes the support step S11 and the detection step S12 which are described in FIG. 5 as above. Note that a turning processing step of subjecting an inspection target having a plate shape to a turning process may be included as a step preceding the inspection step S21 (support step S11).

In the determination step S22, it is determined whether or not the center of gravity of the inspection target 400 which has been identified on the basis of the force in the gravitational direction and the moment about an axis orthogonal to the gravitational direction, the force and the moment having been detected with use of the force sensor 20 in the detection step S12 and acting on the support section 10 from the inspection target 400, is located within an allowable range. The determination step S22 is carried out by the above-described control section 30. In a case where the result of the determination indicates that the center of gravity of the inspection target 400 is located within an allowable range, the process proceeds to “YES” in FIG. 6, and the subsequent processing step (S23) is carried out. Here, in a case where the inspection target 400 is a casting which is a base material of a disc brake plate and which has been subjected to a turning process, for example, the inspection target 400 is shipped.

In contrast, in a case where the result of the determination indicates that the identified center of gravity of the inspection target 400 is located outside the allowable range, the process proceeds to “NO” in FIG. 6, and the subsequent processing step S23 is not carried out.

The above manufacturing method S20 makes it possible to identify an inspection target 400 having the center of gravity located at a position of the center of gravity of the normal product and allow only the identified inspection target 400 to proceed to the subsequent processing step S23. This makes it possible to contribute to accurate manufacture of a product. For example, such an effect contributes to achievement of Goal 9 “Build resilient infrastructure, promote inclusive and sustainable industrialization and foster innovation” of Sustainable Development Goals (SDGs) proposed by the United Nations.

Aspects of the present invention can also be expressed as follows:

An inspection device in accordance with Aspect 1 of the present invention is an inspection device configured to inspect a center of gravity of an inspection target having a plate shape, the inspection device including: a support section configured to, on an upper end portion thereof, support the inspection target; and a force sensor coupled to a lower end portion of the support section and configured to detect a force in a gravitational direction and a moment about an axis orthogonal to the gravitational direction, the force and the moment acting on the support section from the inspection target in a non-rotating state.

According to Aspect 1 above, the detection by the force sensor makes it possible to statically identify a position of the center of gravity of the inspection target. This makes it possible to identify the presence or absence of displacement from a position of the center of gravity of the normal product and to identify whether or not the inspection target is the normal product.

An inspection device in accordance with Aspect 2 of the present invention is configured, in addition to the configuration of the inspection device in accordance with Aspect 1 above, to further include an identification section configured to, on the basis of a result of detection by the force sensor, identify at least one of: a position of the center of gravity of the inspection target; a polar angle obtained in a case where the position of the center of gravity of the inspection target is represented by a polar coordinate in which a position of a center of gravity of a normal product is an origin; and the moment about the axis orthogonal to the gravitational direction.

According to Aspect 2 above, having the identification section makes it possible to inform whether or not the inspection target is the normal product.

An inspection device in accordance with Aspect 3 of the present invention may be configured, in addition to the configuration of the inspection device in accordance with Aspect 1 or 2 above, such that the inspection target has a disc shape.

An inspection method in accordance with Aspect 4 of the present invention is an inspection method for inspecting a center of gravity of an inspection target having a plate shape with use of the inspection device in accordance with any one of Aspects 1 to 3 above, the method including: a support step 41 supporting the inspection target on the upper end portion of the support section; and a detection step of detecting, with use of the force sensor, the force in the gravitational direction and the moment about the axis orthogonal to the gravitational direction, the force and the moment acting on the support section from the inspection target supported in the support step.

According to Aspect 4 above, detection by the force sensor makes it possible to identify a position of the center of gravity of the inspection target. This makes it possible to identify the presence or absence of displacement from a position of the center of gravity of the normal product and to identify whether or not the inspection target is the normal product.

A method for manufacturing a disc brake plate, in accordance with Aspect 5 of the present invention includes the steps of: a turning processing step of subjecting an inspection target which has a plate shape and which is a base material of the disc brake plate to a turning process; and an inspection step of inspecting, with use of the inspection device in accordance with any one of Aspects 1 to 3, a center of gravity of the inspection target which has been subjected to the turning process in the turning processing step.

According to Aspect 5 above, the inspection step makes it possible to identify a plate-shaped inspection target having the center of gravity located at a position of the center of gravity of the normal product and to manufacture a desired disc brake plate.

### [Additional Remarks]

The present invention is not limited to the embodiments, but can be altered by a skilled person in the art within the scope of the claims. The present invention also encompasses, in its technical scope, any embodiment derived by combining technical means disclosed in differing embodiments.

1. An inspection device configured to inspect a center of gravity of an inspection target having a plate shape, the inspection device comprising:
a support section configured to, on an upper end portion thereof, support the inspection target; and
a force sensor coupled to a lower end portion of the support section and configured to detect a force in a gravitational direction and a moment about an axis orthogonal to the gravitational direction, the force and the moment acting on the support section from the inspection target in a non-rotating state.

2. The inspection device according to claim 1, further comprising an identification section configured to, on the basis of a result of detection by the force sensor, identify at least one of:
a position of the center of gravity of the inspection target;
a polar angle obtained in a case where the position of the center of gravity of the inspection target is represented by a polar coordinate in which a position of a center of gravity of a normal product is an origin; and
the moment about the axis orthogonal to the gravitational direction.

3. The inspection device according to claim 1, wherein the inspection target has a disc shape.

4. A method for inspecting a center of gravity of an inspection target having a plate shape with use of an inspection device including
a support section configured to, on an upper end portion thereof, support the inspection target and
a force sensor coupled to a lower end portion of the support section and configured to detect a force in a gravitational direction and a moment about an axis orthogonal to the gravitational direction, the force and the moment acting on the support section from the inspection target in a non-rotating state,
the method comprising:
a support step of supporting the inspection target on the upper end portion of the support section; and
a detection step of detecting, with use of the force sensor, the force in the gravitational direction and the moment about the axis orthogonal to the gravitational direction, the force and the moment acting on the support section from the inspection target supported in the support step.

5. A method for manufacturing a disc brake plate, the method comprising:
a turning processing step of subjecting an inspection target which has a plate shape and which is a base material of the disc brake plate to a turning process; and
an inspection step of inspecting, with use of an inspection device, a center of gravity of the inspection target which has been subjected to the turning processing step,
the inspection device including
a support section configured to, on an upper end portion thereof, support the inspection target and
a force sensor coupled to a lower end portion of the support section and configured to detect a force in a gravitational direction and a moment about an axis orthogonal to the gravitational direction, the force and the moment acting on the support section from the inspection target in a non-rotating state.
